(19) United States
(12) Patent Application Publication
(10) Pub. No.: US 2006/0227146 A1
(43) Pub. Date: Oct. 12, 2006

(54) Systems and methods for media production color management

(75) Inventor: David C. Allen, Denver, CO (US)

Correspondence Address: FAEGRE & BENSON LLP;PATENT DOCKETING, 2200 WELLS FARGO CENTER, MINNEAPOLIS, MN, 55402, US

(73) Assignee: Quark, Inc., Denver, CO (US)

(21) Appl. No.: 11/095,702

(22) Filed: Mar. 30, 2005

(51) Int. Cl. G09G 5/02

(52) U.S. Cl. 345/589

(57) ABSTRACT

Systems and methods for color management are disclosed. Some of the methods are tailored for a desktop publishing environment and include receiving a project definition that indicates a publication tool, and a design tool environment definition that indicates a design tool. Device color guides associated with the publication tool and design tool are accessed, and a color space arbitration between the device color guide associated with the design tool and the device color guide associated with the publication tool is performed. Based at least in part on the color space arbitration, a design color space is provided.

### CROSS REFERENCE TO RELATED APPLICATIONS

The present application is related to U.S. patent application Ser. No. ______ (Attorney Docket No. 56578-315714) entitled “Systems And Methods For Importing Color Environment Information”, and filed by Allen on a date even herewith. Further, the present application is related to U.S. patent application Ser. No. ______ (Attorney Docket No. 56578-309580) entitled “Systems and Methods for Integrated Extended Process Media Productions”, and filed by Allen on a date even herewith. The entirety of the aforementioned patent applications is incorporated herein by reference for all purposes.

### BACKGROUND OF THE INVENTION

The present disclosure describes inventive systems and methods related to producing media productions, and in particular to systems and methods for color management in relation to media productions.

In general, desktop publishing tools portray a designer's work in various color spaces. For example, a layout may be portrayed in one color space for electronic display, and in another color space when portrayed as hardcopy. Conventional wisdom suggests that an electronic portrayal should be formed using one device dependent color space, while the hardcopy is displayed in another device dependent color space. This can result in a disparity between a media product as designed, and the same media product as published.

In some cases a careful designer may adjust one or both of the color spaces to achieve a balance. However, this can be complicated and affected by a number of variables not always transparent to a designer. As an example, the designer may not be aware of the chromaticities of phosphors in a particular monitor, or characteristics of a particular ink. Thus, while it may be possible to achieve a color balance in various instances, such a balance can be complicated and time consuming to achieve and in some cases not achievable.

Hence, among other things, there exists a need in the art for advanced systems and methods for addressing color considerations in relation to media production.

### BRIEF SUMMARY OF THE INVENTION

The present disclosure describes inventive systems and methods related to producing media productions, and in particular to systems and methods for color management in relation to media productions.

Various embodiments of the inventions provide methods for color management in a desktop publishing environment. The methods include receiving a project definition that indicates a publication tool. In addition, a design tool environment definition is received that indicates a design tool. Such a design tool may be, for example, a source or destination design tool. As just some examples, the design tool can be, but is not limited to, a computer monitor, a scanner, a digital still camera, a digital video camera, a digital design tool, and one or more design elements accessible from a computer readable medium. Device color guides associated with the publication tool and the design tool are accessed, and color space arbitration between the device color guide associated with the design tool and the device color guide associated with the publication tool is performed. As just one example, the device color guides can be associated with a proof printer and a scanner. Based at least in part on the color space arbitration, a design color space module is provided.

In some instances of the embodiments, performing the color space arbitration includes calculating a color space common to the publication tool and the design tool. In other instances, performing the color space arbitration includes calculating a color space that maximizes access to colors available from the publication tool. In yet other instances, performing color space arbitration between the device color guide associated with the publication tool and the device color guide associated with the design tool includes defining the design color space to include the gamut of the intersection between a first gamut of the device color guide associated with the design tool and a second gamut of the device color guide associated with the publication tool. In some such instances, the design tool is a scanner, and performing color space arbitration between the device color guide associated with the publication tool and the device color guide associated with the scanner further includes defining the design color space to include a defined color, and the defined color is mapped from the first gamut of the device color guide associated with the scanner to the second gamut of the device color guide associated with the publication tool. As one example, the defined color may be within the second gamut of the device color guide associated with the publication tool, and outside the first gamut of the device color guide associated, with the scanner.

In various instances of the embodiments, the publication tool is a printing press. Such a printing press can be, but is not limited to, a four color press, a four color press plus spot color, and a four color press plus two spot color. In some cases, the project definition further defines at least one ink to be used in relation to the printing press, and the device color guide associated with the printing press is defined based at least in part on the one ink. Further, the project definition may further define a paper, and the device color guide associated with the printing press may be further defined based at least in part on the paper.

In one or more instances of the embodiments, the aforementioned design tool is a first design tool, and the method further includes: automatically querying a design tool environment such that the query yields the first design tool and at least a second design tool. In addition, the first and second design tools are presented, and in response a design tool environment definition is received. In one particular case, the design tool is a computer monitor, and the design tool environment definition further indicates a proof printer and a scanner.

Other embodiments of the present invention provide systems for color management in a desktop publishing environment. The systems include a microprocessor communicably coupled to a computer readable medium. The computer readable medium includes instructions executable by the microprocessor to: receive a project definition that indicates a publication tool; receive a design tool environment definition that indicates at least one design tool; access a device color guide associated with the publication tool; access a device color guide associated with the design tool; perform a color space arbitration between the device color guide associated with the design tool and the device color guide associated with the publication tool; and based at least in part on the color space arbitration, provide a design color space module.

In one particular instance of the embodiments, the design tool environment definition indicates a monitor and a scanner. Further, the device color guide associated with the design tool indicates a gamut of the scanner and a gamut of the monitor, and the device color guide associated with the publication tool indicates a gamut of the publication tool. The design color space has a gamut including a transform of the gamut of the monitor, a transform of the gamut of the scanner, and a transform of the gamut of the publication tool. In another particular instance of the embodiments, the design tool environment definition indicates a proof printer and a monitor. In the instance, the device color guide associated with the design tool indicates a gamut of the monitor, and the device color guide associated with the publication tool indicates a gamut of the publication tool. The design color space includes a gamut including a transform of the gamut of the monitor, and a transform of the gamut of the publication tool.

Yet other embodiments of the present invention provide methods for color management that include defining a publication tool color guide in relation to a printing press, and providing the publication tool color guide to a media production tool. The media production tool is operable to: receive a project definition that indicates the printing press; receive a design tool environment definition that indicates a design tool; access both the publication tool color guide and a design tool color guide associated with the design tool; and perform a color space arbitration between the publication tool color guide and the design tool color guide. This arbitration defines a color environment.

Yet additional embodiments of the present invention provide methods for color management in a desktop publishing environment. The methods include maintaining a plurality of design tool color guides that define a gamut associated with a particular design tool; maintaining a publication tool color guide that defines a gamut associated with a particular publication tool; receiving a selection of at least one of the design tool color guides and the publication tool color guides; and based at least in part on the at least one of the design tool color guides and the publication tool color guide, defining a design gamut.

Yet further embodiments of the present invention provide systems for color management. The systems include an execution unit and a computer readable medium. The computer readable medium includes instructions executable by the execution unit to: receive a source color space; receive a display designation; and based at least in part on the source color space and the display designation, converting the source color space to a destination color space. In some instances, the source color space can be, but is not limited to, RGB space, CMYK space, and LAB space. Further, in some instances, the display designation is a complex display designation that, for example, indicates an output device and an output media. Such an output device can be, but is not limited to, a printer and a printing press. Further, such output media can be, but is not limited to, an ink and a paper.

This summary provides only a general outline of some embodiments of the present invention. Many other objects, features, advantages and other embodiments of the present invention will become more fully apparent from the following detailed description, the appended claims and the accompanying drawings.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 are representative depictions of various color spaces in relation to one another;

FIG. 2 depicts a system of color transformation modules;

FIG. 3 depict systems for comprehensive output color management in accordance with various embodiments of the present invention;

FIG. 4 is a system for comprehensive color mapping is depicted in accordance with one or more embodiments of the present invention;

FIG. 5 is a flow diagram illustrating a design method in accordance with one or more embodiments of the present invention; and

FIG. 6 is a flow diagram illustrating another design method in accordance with various embodiments of the present invention.

### DETAILED DESCRIPTION OF THE INVENTION

The present disclosure describes inventive systems and methods related to producing media productions, and in particular to systems and methods for color management in relation to media productions.

As used herein, the term “color space” is used in its broadest sense to mean a gamut of different colors. Thus, as some general examples, color spaces can be, but are not limited to, RGB, XYZ, LAB, and CMYK color spaces. Each of the aforementioned color spaces generally encompasses a different set or range of colors with some colors common across many color spaces and other colors represented in only one or a few color spaces. Further, within each of the aforementioned general color spaces there can exist many color spaces.

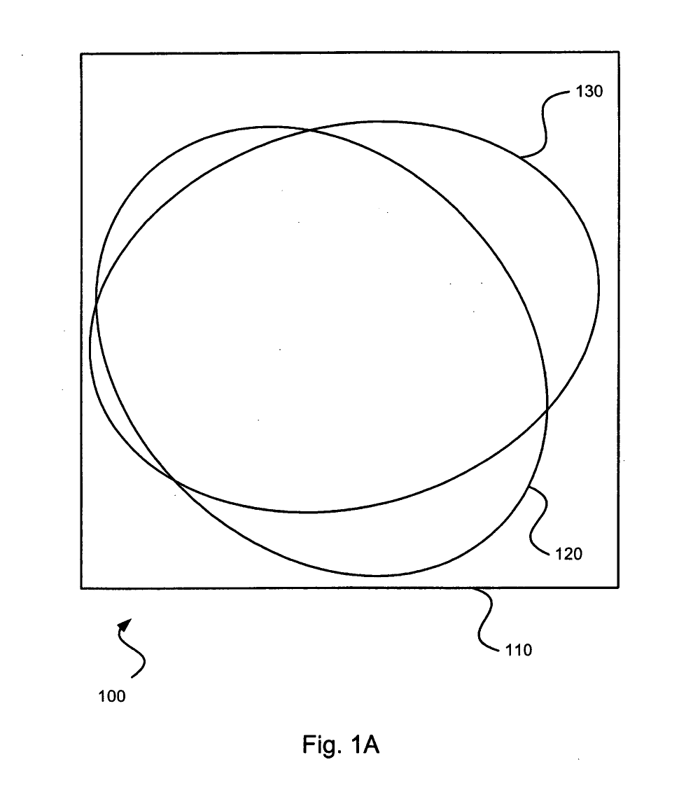

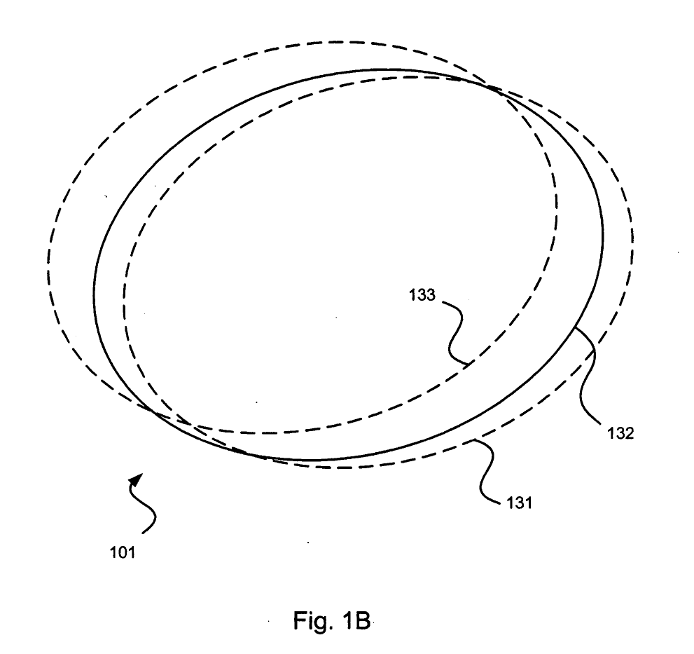

FIG. 1A provides a graphical depiction 100 of three distinct color spaces 110, 120, 130. In the depiction, color space 110 includes a broad range of colors falling within the rectangular area. The range of colors may be, for example, all colors that are perceptible by humans. This could be, for example, an XYZ color space or a LAB color space as are known in the art. In particular, XYZ and LAB (i.e., CIELab) are color spaces designed to encompass substantially all of the range of human color perception, and reduced to a quantitative form. These color spaces provide a mathematical notation of color based on human perception. Such a broad color space provides a useful source or translator because it embodies all or substantially all human visible gamuts that are available by design tools and publication devices. For the purposes of this document, such a broad color space is referred to as a “device independent” color space. The other color spaces 120, 130 are subsets of the larger color space 110, and include colors falling within the respective oval areas. As one example, color space 120 may be an RGB color space, and color space 130 may be a CMYK color space. Such color spaces may be those available when using a particular design tool or publication tool and are referred to herein as “device dependent” color spaces. Depiction 100 is merely illustrative of the fact that different color spaces are capable of displaying different colors, and that some colors are available in many color spaces, and other colors are available only in limited color spaces.

Color spaces are often represented through the interaction of physical elements such as, but not limited to, paper and ink, or electric signals and phosphors. Thus, as an example, where a CMYK color space is chosen for a print job formed of ink on paper there can be hundreds or more CMYK color spaces depending upon qualities of the ink and paper chosen to represent the color space. In some cases these differences are not perceptible, while in other cases they are not only perceptible, but are substantial. Thus, a media production formed by one printer may be vastly different than that formed by another printer even though both are using the same CMYK color space.

In particular, the paper upon which a media production is printed defines the white point affecting the entire color gamut by way of a ripple affect. In addition, the absorbency of the paper causes dot gain which, even when properly compensated for, affects the printing gamut. Thus, even something as simple as changing ink manufacturers can change the overall gamut of the press. A quantifiable value of a mixed color is contingent on the values of the component colors being mixed. In other words, the color value of cyan from one ink manufacturer may not be consistent with the value of cyan ink from another manufacturer. Therefore, the recipe for a given color on a press using a certain set of inks may require a different color recipe on the same press using a different set of inks. For example, if you mix 100% cyan and 100% magenta inks from one ink company to produce a specific purple, you may find that you need to mix 99% cyan and 99% magenta inks from another ink company achieve the same result. Various embodiments of the present invention address the solutions for these sorts of color management opportunities.

The term “ink” is used in its broadest sense herein to denote a colorant. Inks are often chosen from ink libraries such as, but not limited to, pantone coated or TOYO. Based on the disclosure provided herein, one of ordinary skill in the art will recognize a variety of inks and/or ink libraries that can be used in accordance with one or more embodiments of the prior art. For example, an ink can be created from an arbitrary color space such as CMYK or RGB and identified as a spot color.

FIG. 1B provides a graphical depiction 101 of three distinct manifestations of the previously described color space 130 that are respectively labeled color spaces 131, 132, 133. In the depiction, each of the color spaces 131, 132, 133 incorporates a similar range of colors, albeit slightly different depending upon the inks, paper, phosphors, and/or other physical elements effecting the color space. Thus, for example, all three color spaces 131, 132, 133 may be CMYK color spaces affected by three respective qualities of paper. Depiction 101 is merely illustrative of the fact that color spaces are affected by various physical elements involved in a media production.

Further, the color reproduction process can occur in several phases of the media production process, with each phase of the process possibly resulting in a compromise in the range of available colors. As one example, it could be imagined that a conversion is performed from color space 120 to color space 130 of FIG. 1A that would result in only the colors included at the intersection of the two color spaces being made available for design purposes. Because each color space conversion may decay the breadth of available colors, each phase of a media production process offers opportunities for improving the media production through some form of color management.

As a more particular example, when colors are transformed from a source color space to a destination color space, certain compromises often occur. Colors that exist in one space do not necessarily exist in another. In this case, choices have to be made to map the color from the source to the most desirable color in the destination. In some cases, this transaction is more complicated than it may initially appear as mapping a color from one color space may affect its relationship with surrounding colors. Thus, in some cases, rendering intent (i.e., a consideration of the layout as a whole) is utilized in controlling the color mapping.

An example of a typical series of color reproduction tasks include: 1) taking a photograph, 2) scanning the photograph on a scanner to make an electronic representation of the photograph, 3) providing the electronic image to an image setter, and 4) printing the image on an offset press. Color management performed at each one of these steps may sequentially reduce the range of color possibilities. Furthermore, the range of color possibilities or gamut demonstrated by each stage in this example may vary from one device to the next. The film from one manufacture, for example, has a different gamut than film from another—the gamut of one scanner is different from that of another, and so forth. To address these situations, various embodiments of the inventions provide systems and methods that account for varying physical elements and/or devices utilized in relation to a particular color space. Also, as more fully set forth below, various embodiments of the present invention provide for an intelligent color conversion scheme that seeks to limit the amount of decay occurring in the color management process.

In particular instances of the inventions, the output devices used in producing a media production are calibrated for a desired color space and include device color guides defining the color space, and the input devices are also defined by device color guides that characterize color provided by the input devices. The terms “publication tool” and “design tool” are used herein to include input and output devices associated with producing a media production. In general, a “publication tool” is the intended final output of the media production. Thus, for example, a production tool may be, but is not limited to, a printing press where the media production is to be printed, or a computer monitor where the media production is to be accessible via an Internet site. In general, a “design tool” is any tool used in developing the media production to perform the design processes occurring before the media production is sent to the production tool. Thus, for example, a design tool may include, but is not limited to, a scanner, a digital camera, a computer monitor, a proof printer, a computer readable medium including one or more design elements or images, an image capture board, and/or the like. Based on the disclosure provided herein, one of ordinary skill in the art will recognize a variety of design tools and production tools that can be used in accordance with the present inventions.

Design elements or images accessible from a computer readable medium are typically maintained in image file formats. A TIFF file format, for example, is a file format that is considered to be an image. These images available from the computer readable medium are rendered using a color space such as, but not limited to, Grayscale, RGB, CMYK, LAB and Multi-Channel (PSD files). Images described in any one of these color spaces may be eligible for transformation into completely different destination color space.

Using the quantitative definition of color provided by a device independent color space, such as LAB, it is possible to describe the gamut of a particular device in at least two ways: 1) via the device's mathematical recipe of color, and 2) via the device's colorant recipe. As used herein, the combination of these two sets of recipes is referred to as a characterization. Such a characterization may be included in a device color guide associated with the particular device. For simplicity, the term “device color guide” is used herein in its broadest sense to denote a computer readable file that may include, for example, an International Color Consortium (“ICC”) color profile representing the capabilities and/or color gamut useable via the device, a transform recipe from the device to a particular device independent color space, from the device to a particular device dependent color space, to the device from a particular device independent color space, and/or to the device from a particular device dependent color space. Where the recipe is for a transform from one device dependent color space to another device dependent color space, it may be a compound transform from the first device dependent color space to a device independent color space and from the device independent color space to the second device dependent color space. Thus, a device color guide may include one or more transform recipes, and/or ICC profile information.

If a device has a profile that maps all of the colors in the LAB space into specific colorant recipes for that device, it has in effect managed the colors. Where not all LAB colors are supported by a particular device, intelligent decisions can be made for how to replace unsupported colors with supported colors if the color possibilities (i.e., color space) of the target device is known. Alternatively, color management may be achieved by precluding use of colors in the LAB color space that are not also available in the device dependent color space.

Some embodiments of the present inventions include color management integrated into a desktop publishing environment, and provide improvements over limited color management approaches provided to date. In some cases, the embodiments provide for modeling the color features available to a user of a desktop publishing software in a medium-independent framework. A medium independent framework for color management is one which does not prefer any single medium over any other. In some embodiments of the present invention, the medium independent framework is achieved by storing and/or conveying color information in a device independent color space (e.g., LAB or XYZ), and converting to device dependent color space (e.g., RGB or CMYK) only when necessary. In addition, conversion into device dependent values may be made directly from the device independent data. Thus, for example, if it is intended to output to a CMYK color space supported by a printer and the information is stored in XYZ color space, the information may be converted from XYZ to CMYK, as opposed to converting from XYZ to RGB and then from RGB to CMYK. This “middle man” step is not only computationally wasteful, but also imposes gamut restrictions particular to the RGB color space (note that conversion between two device independent color spaces such as LAB and XYZ does not in general impose any gamut restrictions). Other embodiments provide for conversion to/from a device dependent color space in an effort to achieve a similar output media production as that seen by the user during the design process. In such a case, the default or design color space (i.e., color environment) may be chosen to be equal to that of the output printing press, with all other design tools being mapped to that color space.

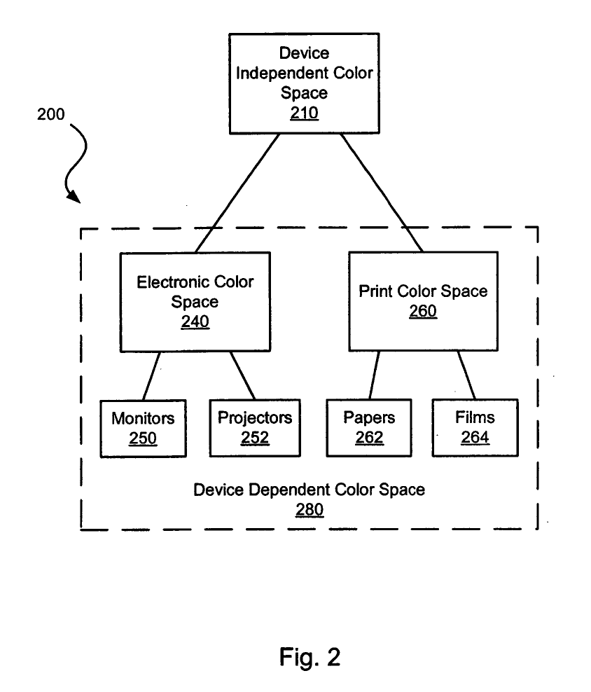

Turning to FIG. 2, a system 200 includes transformation modules that allow for conversion between a device independent color space 210 and a device dependent color space 280. Device independent color space 210 is the color space that is often utilized to represent a media production under design. The media production under design can be displayed in a medium specific electronic color space 240 that is tailored for either a particular electronic monitor 250 or a particular projector 252. Further, when the media production is ready for printing it can be transformed to a medium specific print color space 260 which is tailored for a particular paper printing process 262 or film processes 264. Based on the disclosure provided herein, one of ordinary skill in the art will recognize a number of particular color spaces to which a media production created in a design independent color space may be converted. Further, one of ordinary skill in the art will appreciate a number of devices with associated device color guides and device dependent color spaces that can be used in relation to embodiments of the present invention.

A design suite setup such that the monitor and proof printer closely map to the selected production tool are referred to herein as a display simulation setup. Also as used herein, the term “display simulation” is used in its broadest sense to mean any method whereby “soft proofing” of a media production can be performed via a display. With the complex notions of source verses destination color spaces and rendering intents, it becomes difficult to make the best decisions in terms of color selection. Proofing final output can help the user make color critical decisions without necessarily having to use expensive output devices for proofing. In one particular embodiment of the present invention, display simulation functionality includes: the ability to specify a rendering intent, and the ability to select the output setup to simulate on a display. With the display simulation, a user may be able to view via a computer monitor how solid colors/inks may have been repurposed for output. For example, the user can create a full color layout comprising a number of different color spaces and inks. Through the display simulation, the user can specify an output setup to be simulated so the layout can be viewed in, for example, Grayscale, Process & Spot, or Hexachrome complete with Ink Mapping.

Various embodiments of the present invention provide a desktop publishing suite that incorporates one or more of the following functional features: opening legacy documents and display/output such documents using a source setup that replicates outdated versions of the suite used to originally create the document; assigning source, display and output setups introduced by the latest version the suite to a document created in a previous version of the suite; configuring source, display and output setups using ICC standard profiles and assigning them to layout spaces. Layout spaces are more fully described in U.S. patent application Ser. No. 10/980,208, entitled Systems and Methods for Multi-Format Media Production, and filed on Nov. 2, 2004, by Varela et al. (the aforementioned application is assigned to an entity common hereto and incorporated herein by reference in its entirety and for all purposes); configuring source, display and output setups for each layout space independently; applying default source, display and output setups to layout spaces using a web medium type; applying default Source, display and output setups to layout spaces using a print medium type, color managing RGB sources to various destination color spaces; color managing CMYK sources to various destination color spaces; color managing LAB sources to various destination color spaces; color managing hexachrome sources to various destination color spaces; color managing named color sources to various destination color spaces; color managing ink sources to various destination color spaces; color managing grayscale sources to various destination color spaces; color managing various sources to RGB destination color spaces; color manage various sources to CMYK destination color spaces; color managing various sources to hexachrome destination color spaces; color managing various sources to grayscale destination color spaces; and color managing various sources to user defined destination color spaces.

Some embodiments of the present invention provide a color space management system that allows users to see exactly what is being done in terms of color management, and to make detailed adjustments in the way the system is dealing with color. This may be a user selectable option that allows other users to ignore the detailed color management processes being implemented through application of default color management rules. These default color management rules may be based on ICC profiles used by the systems. Where a user wanted to override the default rules, they could replace or modify one or more of the ICC profiles. In one particular case, the systems include a source setup module, a display simulation module, and output setup module. In one case, the system is a piece of software and each of the modules is a portion of the software. The source setup module establishes the source color spaces of all input colors. From the source setup module, colors are transformed using standard ICC methods to the display simulation module and output setup module independently. In some cases, all three of the modules are considered medium dependent because they provide options specific to medium types.

In some cases, solid colors are custom instances created from a single color space, such as RGB, LAB or CMYK. Once created, the color is named. Alternatively, solid colors can be chosen from a color library such as Pantone. When solid colors are to be fixed on a printed medium, they are transformed into another color space such as, for example, CMYK or Hexachrome, and represented by a combination of printing inks. For example, CMYK, LAB or RGB solid colors may be separated into some combination of Cyan, Magenta, Yellow and Black inks when a printing press that utilizes CMYK color space is selected. The same solid colors would be split into some combination of the Hexachrome process inks when a printing press that utilizes Hexachrome is selected. In some cases, solid colors are represented in multiple color spaces such as RGB, LAB, and CMYK. For the purposes of this document, such multi-color space solid colors are referred to as named colors. Where conversion is done for a named color, it may be that the named color is already represented in the destination color space, or that one of the color space representations of the named color provides a better conversion source than another.

The process of reducing a named or solid color into a primitive ink representation for output on a printing press is generally referred to herein as “separation”. In general, the primitive inks or separations are printed on discrete printing plates in order to be processed and put onto the printing press. The specified inks are transferred from the plates, one ink component after another, in order to re-composite a representation of the original color. In some cases colors are formed a mixture of ink specifications, such as a multi-ink, from which a composite color is derived. In other cases the composite color is selected from a color model, such as RGB or CMYK, and the inks have to be derived from that composite color. In the case of multi-inks, the separation inks may already be specified. In the case of CMYK colors, the composite color may be mapped to Cyan, Magenta, Yellow and Black inks. In the case of another color space such as, for example, RGB, a transform is applied in order to map the RGB colorants into the desired ink set.

As used herein, the term “source color space” denotes a color space used by a device in creating a design element, or the color space in which a design element was represented prior to a transform. Thus, as just one example, if an image is scanned on an RGB scanner, its source color space is RGB. In some cases where a color is transformed from one color space to another, the color space representing the color to be transformed is referred to as the source color space. Also, as used herein, the term “destination color space” is a color space in which a design element is represented after a color space conversion has been performed. As just one example, where colors created from multiple source color spaces are placed into a single layout, each color in the layout may be converted to a single destination color space. This destination color space may be, for example, a color space offered by a selected printing press that accounts for the inks and paper to be used by the printing press.

In some cases, a layout is described as a number of design elements, with each of the design elements potentially represented in a different color space. Alternatively, in some cases, a layout is described as a “composite output” with design elements combined with other design elements and represented or described in a single color space. This may occur, for example, where the layout is represented as a PDF or PostScript output. In such cases, it may be that individual colors of design elements are not capable of receiving application of any complex ink properties, such as applying spot inks to grayscale TIFFs or Multi-Inks to objects without the use of DeviceN. It may be that the complex ink properties that can be applied to a composite output are some combination of Cyan, Magenta, Yellow or Black. This layout may be maintained in an authoring environment and set apart from any final color space formalities.

As used herein, the term “DeviceN” is a PostScript convention whereby a list of ink names and an alternate color description is stored in a dictionary. When an object is described, its color is defined using a routine that lists the inks and ink percentages comprising the objects color. If the object is being separated, the ink percentages are extracted and turned to halftones and printed on their respective plates using grayspace. If composite output is being printed, each ink percentage is multiplied against each colorant in the ink's alternate color space. Then, the colorants are added together to compose a single composite color. In some cases, using the DeviceN capability of describing complex inks applied to a single object, it is made possible for a PostScript level 3 device to separate the ink specifications onto discrete printed plates. The PostScript level 3 device, while in separation mode, defines a current plate, then reads each object in the PostScript description and extracts the ink percentage of each object for that plate. This is repeated for every plate defined by the PostScript file's ink list.

As used herein, the term “source setup” is used in its broadest sense to mean any configurations of source colors. For example, a source setup may specify source configurations for RGB, CMYK, LAB, Inks and Named Color sources. A variety of these source setups can be created at a project level, named and applied to layout spaces independently. As used herein, the term “output setup” is used in its broadest sense to mean any color setup directed to designated output. There are several aspects to color output. In the context of printed output you could have composite or separations. Depending on which is chosen, a designer has a variety of color options like: grayscale, CMYK, RGB and DeviceN in composite output mode and Process, Process & Spot and Hexachrome in separation mode. The idea behind the output setup is to define the mode (separations or composite) the space (RGB, CMYK, DeviceN, etc), assign an ICC profile defining the destination color space, Ink Map, name and save the setup. Once that setup is saved, it can be accessed by name in the display simulation and at output time through PDF, EPS and PostScript printing. The ability to map device colors (i.e. Gray, RGB and CMYK) to CIE (CIE 1931 XYZ) allows for devices with robust Color Rendering Dictionaries (CRD) to do their own conversion from XYZ into the device's native color space also known as the device's Process Color Model. For example, If the device that uses CMYK process color model and has a CRD that embodies the SWAP gamut, all colors whose sources are gray, RGB or CMYK that are remapped to CIE will be transformed through the devices CRD into the Process Color Model—CMYK. This method optimizes color fidelity and allows the same description to be transformed in different ways to different devices. The color specifications in the PostScript stream are device independent while the actual rendering remains device dependent. Inks that are described using DeviceN will only be eligible for the CIE re-mapping when the alternative color space is used. This will be most common in composite output. In the case of in-RIP separations, all elements described in device color spaces will separate using the devices CRD and Process Color Model while all inks specified using DeviceN will use the tint transform and render as there own plates. The re-mapping device colors to CIE functionality is an option available to the Output Setup while using the As Is Output Model.

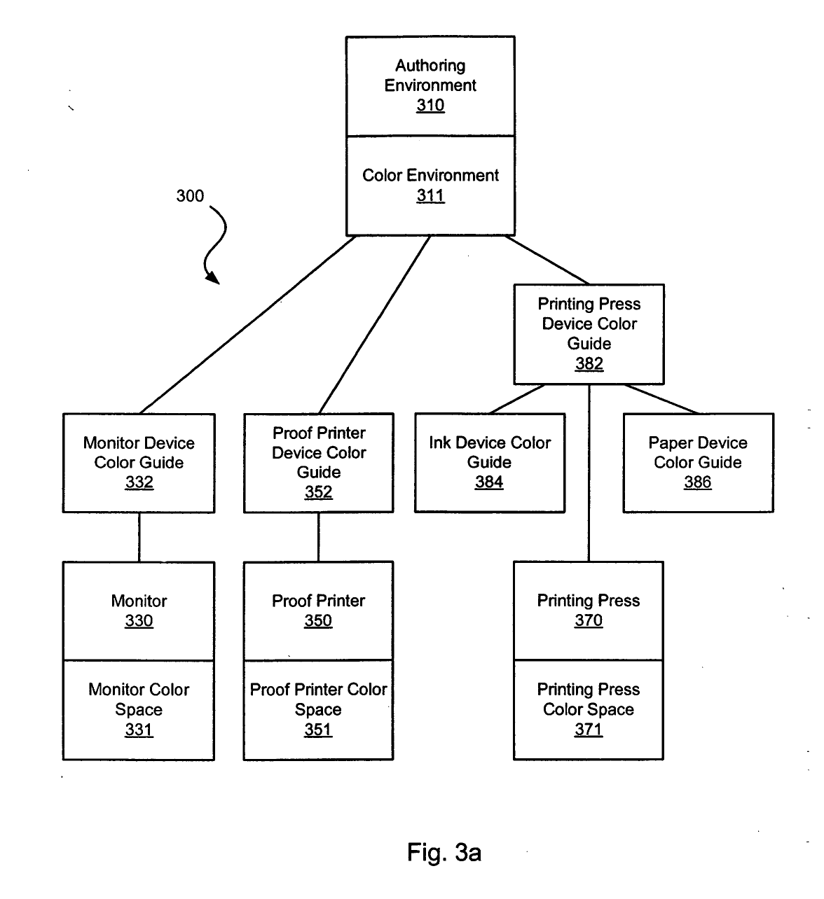

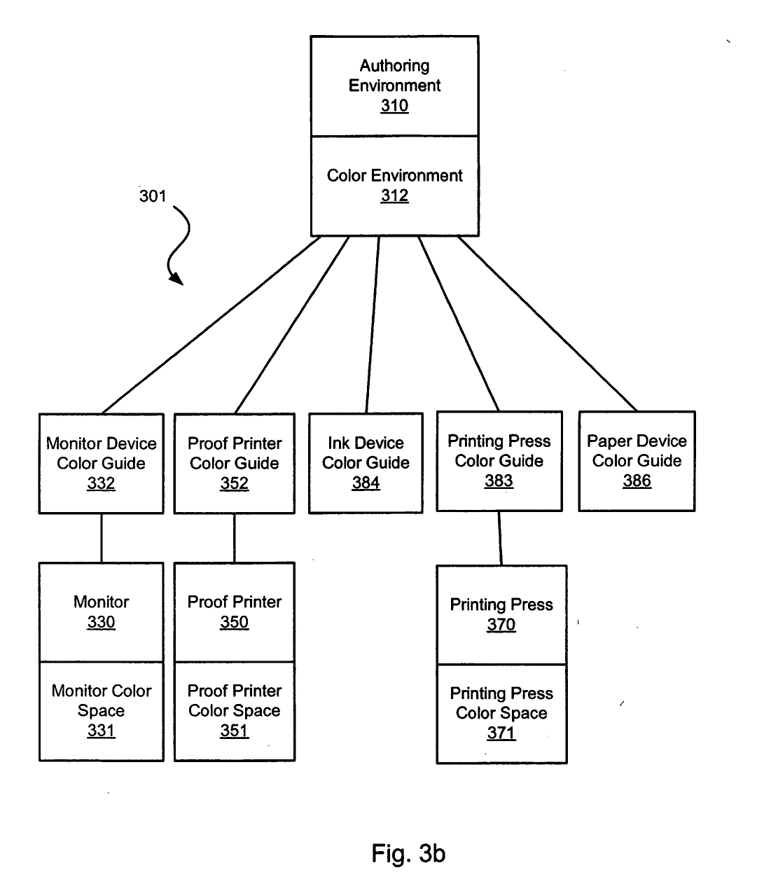

Turning to FIG. 3a, a system 300 includes an authoring environment 310 and a separate color environment 311. In some embodiments of the present invention, authoring environment 310 is an environment where design elements are incorporated in a design independent color space. Thus, a design to be printed or otherwise manifested may be created in an authoring environment that is not fixed to a particular color space. When associated with color environment 311, a design color space is applied to authoring environment 310 to form a design in a particular color space. Color environment 311 is defined as an arbitration between the different input and output color spaces associated with a given design and indicated by device color guides associated with the different input and output devices. As just one advantage of de-coupling authoring environment 310 from color environment 311, a different set of input and output devices may be selected which changes color environment 311, but does not necessarily require modification of authoring environment 310. Thus, color independent or quasi color independent designs can be formed in authoring environment 310 with a color environment applied thereto. In some embodiments, color environment 311 is formed using an understanding of the various color spaces for selected input and output devices to provide an optimal transformation between the various color spaces and the selected output color space.

As an example, a designer or other entity may select a particular printing press 370, proof printer 350, and monitor 330 to be used in creating a design to be fixed on a printed document. A monitor color space 331 is associated with the selected monitor 330, a proof print color space 351 is associated with the selected proof printer 350, and a printing press color space is associated with the selected printing press 370. As just one example, monitor color space 331 may be an RGB color space dictated by the phosphors of monitor 330. This color space information is provided as a monitor device color guide 332. This device color guide would typically be provided by the manufacturer of the monitor, and is provided as a computer readable file. Similarly, proof printer color space 351 may be an RGB color space dictated by the inks available to proof printer 350 as well as paper to be used on proof printer 350. This color space information is provided as a proof printer device color guide 352. This device color guide would typically be provided by the manufacturer of the proof printer, and is provided as a computer readable file.

In some embodiments, as illustrated by FIG. 3a, a complex printing press device color guide 382 is provided by an operator of printing press 370 as a combination of printing press information, ink information, and/or paper information. Printing press information is dictated by a printing press color space 371 that is associated with printing press 370. Thus, for example, printing press color space 370 may be a four color CMYK color space. Based on the disclosure provided herein, one of ordinary skill in the art will appreciate a number of other printing press color spaces, such as, but not limited to, a CMYK five color press or a CMYK four color press with special plates capabilities. In addition, ink information includes color space information typically available from the ink manufacturer and provided as an ink device color guide 384 which is a computer readable file. Paper information includes color space information typically available from the paper manufacturer and provided as a paper device color guide 386 which is a computer readable file. As illustrated, this information is assembled by the owner of printing press 370 as a single complex printing press device color guide 382. Complex printing press device color guide 382 is available as a computer readable medium that is provided for use in relation to defining color environment 311. Complex printing press device color guide 382 may be provided to an entity responsible for media production design, and used to form color environment 311 in a design tool operated by the entity.

Color environment 311 utilizes monitor device color guide 332, proof printer color guide 352, and printing press device color guide 382 to create a color environment that defines a design color palette. This design color palette is then applied to a design maintained in authoring environment 310. In some cases, the applied color palette is available in monitor color space 331, proof printer color space 351, and printing press color space 371 as modified by ink device color guide 384 and paper device color guide 386. Thus, what a designer sees using monitor 330 is the same as that available from proof printer 350 and printing press 370. Again, by maintaining color environment 311 apart from authoring environment 310, the possibility of color chasing (as is more fully discussed in the following paragraph) is reduced or eliminated.

Such an approach represents a substantial improvement over existing approaches to color management. For example, in some existing approaches a designer uses a proof printer and a monitor to create a design document tied to a particular color space. Once the design is complete, a printing press is selected. In many cases, the selected printing press uses a different color palette than that used to complete the design. Thus, the design has to be redone to address the color palette availability. This is generally referred to as “color chasing”, and results in substantial frustration as well as wasted time and resources. Alternatively, a selected printing press may be replaced by another. This can also result in color chasing. As will be appreciated by one of ordinary skill in the art upon reading this document, various embodiments of the present invention alleviate the possibility and affects of color chasing without requiring that a designer become and expert in the intricacies of color management.

Another example as illustrated in FIG. 3b includes a system 301 similar to that of system 300 includes a color environment dictated not by a complex printing press device color guide, but by a simple printing press device color guide 383. In such an embodiment, ink device color guide 384 and paper device color guide 386 are available directly to color environment 312. Thus, an owner of printing press 370 is only responsible for providing simple printing press device color guide 383, and the designer is free to choose paper and inks with their corresponding device color guides. These device color guides can then be assimilated directly into color environment 312. Such an approach can be particularly advantageous for a number of reasons. For example, a designer or others involved in preparing a media production may intend to use paper or inks not directly available from the owner of printing press 370, or even known to the owner. This way those associated with preparing the media production can select whatever they desire without necessarily involving the owner of printing press 370. Further, it may not be practical for the owner of printing press 370 to provide a complex device color guide accounting for all papers and inks that may be selected by those preparing the design of the media production.

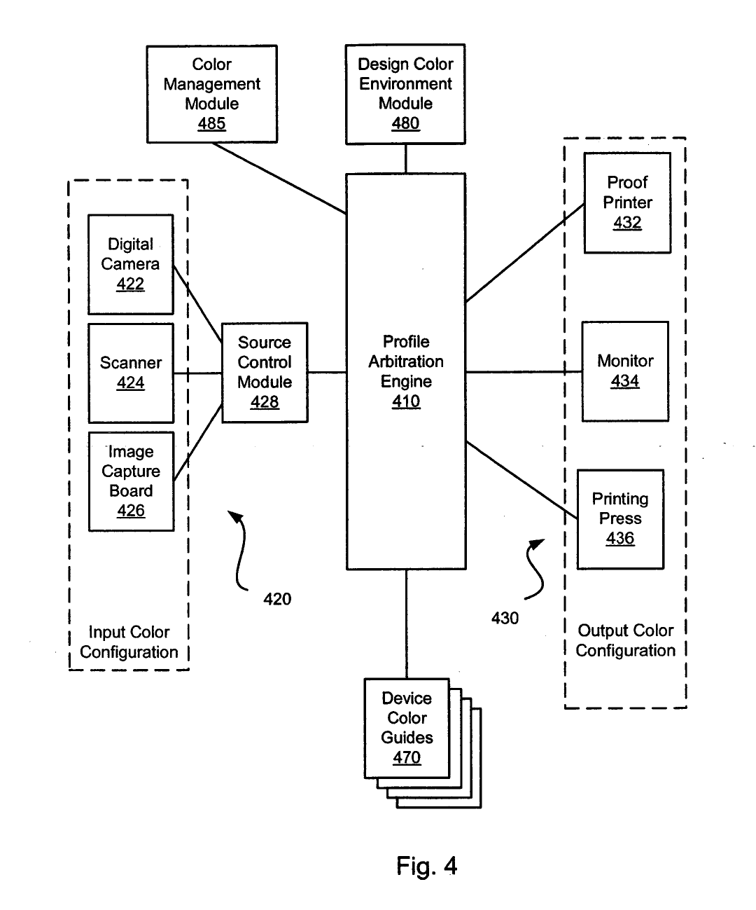

Turning to FIG. 4, a system 400 for comprehensive color mapping is depicted in accordance with one or more embodiments of the present invention. System 400 includes an input color configuration 420 capable of accounting for a variety of input devices each of which can be managed using a source setup command. Each of the input devices is a tool for receiving input information in one or more particular color spaces. Such input devices can be, but are not limited to, a digital camera 422, a scanner 424, an image capture board 426, and/or the like. Input information from the devices is received via a source control module 428 that is responsible for providing the information to a profile arbitration engine 410. Also, an output color configuration 430 is provided that is capable of accounting for a variety of output devices each of which can be managed using a destination setup command. Such output devices can be, but are not limited to, a proof printer 432, a monitor 434, a printing press 436, and/or the like. As more fully described below, arbitration engine 410 is responsible for directing the transformation of information from various color spaces to a design color space and/or an output color space. Output information to the devices is provided as directed by profile arbitration engine 410 using a color palette that seeks to render outputs from the various output devices equal in color.

Color environments 311, 312 as described in relation to FIG. 3 above are the equivalent of or dictated by design color environment module 480. In some cases, design color environment module 480 represents a device independent color space, while in other cases it represents a device dependent color space. Thus, for example, where an output printing press 436 is selected, design color space module 480 may indicate a color space that conforms to that of output printing press 436. Alternatively, where the design is destined for electronic distribution and display, the design color space may be an RGB color space directed to one or more types of electronic monitors. Based on the disclosure provided herein, one of ordinary skill in the art will recognize a variety of design color spaces that can be used in accordance with embodiments of the present invention. Further, as previously discussed in relation to FIG. 3 above, design color environment module 480 may define a design color palette that assures similarity between all output devices used in preparing a media production, or some subset of output devices used in preparing the media production.

Profile arbitration engine 410 is capable of directing the transformation of information from one of input devices 420 to a color space indicated by design color space module 480. In a typical scenario, profile arbitration engine 410 is made aware of a variety of input and output devices to be utilized in preparing a media production. Based on the device color guides 470 associated with one or more of the input and output devices, a color palette available for design is reported via design color environment module 480. In addition, profile arbitration engine 410 identifies color space conversions that will need to be performed to allow for color conversions to/from the various input and output devices and the color palette defined in design color environment 480. These conversions are referred to herein as “routes” between one color space and another, and are chosen to optimize the proposed color conversion and/or reduce computation required for such conversions. Once the routes are determined by profile arbitration engine 410, inputs received from the various input devices are sent to a color management module 485 where the conversions are performed. As will be appreciated by one of ordinary skill in the art reading this disclosure, conversions between color spaces are well known in the art. In addition, appropriate conversion routes are implemented through color management module 485 to send the design or portions thereof to one of the selected output devices. Again, the applying the actual conversion formula for transforming from one color space to another is well known in the art, while the approaches consistent with the present invention for directing the conversions are novel.

Device color guides 470 associated with the various input and output devices are used as described in relation to FIG. 3 above to define design color environment module 480. Thus, selecting a device includes accessing one of the device color guides 470 that is associated with the selected device. The information from the device color guide is then used to form design color environment module 480. Where a device is added or deleted, a modification may be made by profile arbitration engine 410 to design color environment module 480 to reflect the change. Thus, color management can be performed on a plug and play type basis. This approach provides for a complex color management scheme that is largely transparent to a user. Said another way, the color management scheme can be applied by a user through selecting available input and output devices that are associated with device color guides. The device color guides are then used in the background by profile arbitration engine 410 to create a color environment. This alleviates the need for a user to deal with the minute details of color management. This can be quite an advantage where most users are not capable of properly adjusting a color environment.

In operation, a media production in progress can be displayed to a monitor 434. This can include transforming the media production to a color space consistent with monitor 434. Thus, for example, a color palette defined by design color environment module 480 may be converted to an RGB color space particular to monitor 434. Similarly, the media production can be converted for production on proof printer 432 and/or printing press 436 using a similar conversion process. As just one example, printing press 436 may use a CMYK color space for which a conversion from the color palette defined by design color environment module 480 to CMYK particular to printing press 436 can be performed, while proof printer 432 may be an RGB color space for which a conversion is performed.

Each of the color spaces may be particular to a given input device 420 or output device 430. Thus, for example, while an image capture board 426 uses an RGB color space, it may be a particular type of RGB reflected in the device color guides 470 associated with image capture board 426. As another example, printing press 436 may use a CMYK color space, but it will be a particular CMYK color space impacted by the inks and paper to be used on printing press 436. A device color guide 470 associated with printing press 436 may reflect printing press 436 including the ink and paper selection. Alternatively, there may be a device color guide associated with printing press 436, another device color guide associated with the selected inks, and yet another device color guide associated with the selected paper. These device color guides may be combined to define a final device color guide for printing press 436.

As discussed in relation to FIG. 3 above, system 400 can be used to create a design environment which limits differences in color perceived by the designer during the design process, and that color ultimately output to printing press 436. In such an approach, a designer selects a particular printing press, printing paper, and inks that will be used to produce the media production under design. For each of the selected printing press, printing inks, and printing paper, a corresponding device color guide 470 is selected and made accessible to profile arbitration engine 410. These device color guides are combined to form a color palette for printing press 436. This color space is defined in design color environment 480, and becomes the color palette to which monitor 434 and proof printer 432 are conformed. To conform the color spaces, each color used in a media production under design is transformed for production on printing press 436. For each of the transformed colors, a color similar to that available on printing press 436 is defined for each of monitor 434 and proof printer 432. These conversions are then maintained in respective color space definitions associated with proof printer 432 and monitor 434. This helps to assure that what is depicted on the monitor and proof printer are closely mapped to that which will be printed on the printing press. Where the device independent layout is directly transformed to each of the color spaces (e.g., monitor color space, proof printer color space, and printing press color space) the colors may be substantially different. This leads to a misrepresentation of the media production from one output device to another. In contrast, where each of the transforms is guided by the printing press color space, the representation across all three outputs may be closer.

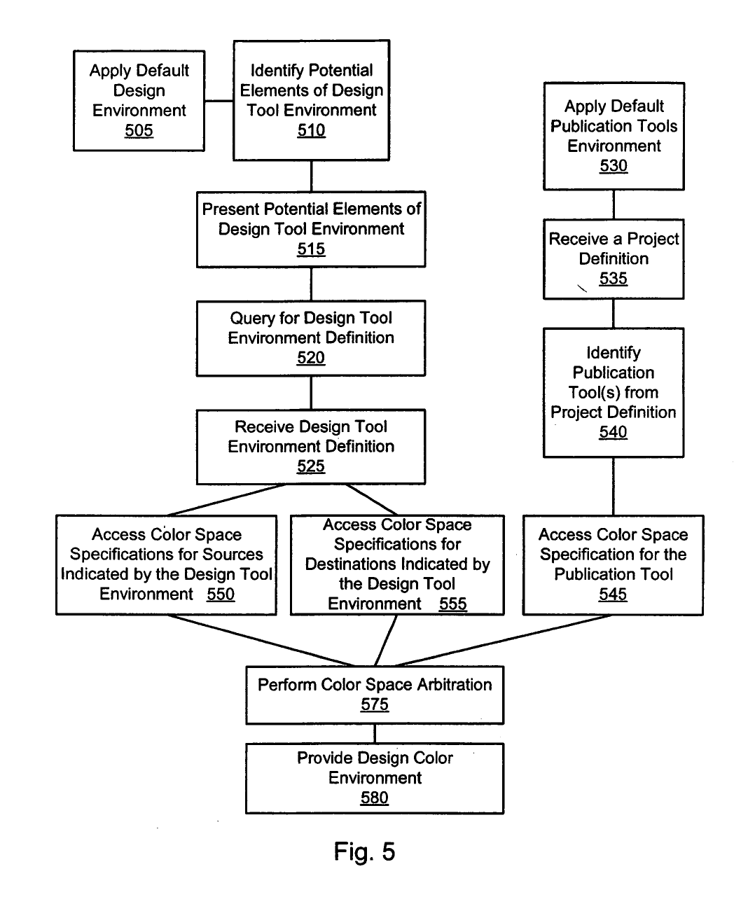

Turning to FIG. 5, a flow diagram 500 illustrates a design method in accordance with one or more embodiments of the present invention. Following flow diagram 500, a default design environment is applied (block 505). This default design environment selects a predefined design color space in which a media production will be created. In one particular case, the default design environment is a LAB color space environment. Various potential elements of the design tool environment are selected (block 510). This can include, but is not limited to, selecting a scanner and a digital camera that will be used for importing images for use in a given design, and for selecting a monitor and proof printer that will be used in relation to creating the design. These selected design tool elements are identified to the design tool environment (block 515), and a query is performed to identify device color guides associated with the selected design tool elements (block 520). Where these device color guides have already been loaded they are accessed, otherwise the user is queried to load one or more device color guides (block 525). With the design color guides loaded, the design tool can access the color guides to create the design environment (blocks 550, 555).

In addition, a default publication tools environment is loaded (block 530). This default publication tools environment selects a predefined publication color space to which the media production will be sent for publication. In one particular case, the default publication tools environment is a LAB color space environment. A project definition is received (block 535), and the project definition is queried to determine publication tools that have been selected for the particular media production (block 540). The publication tools can include, but are not limited to, the specific printing press, printing paper and inks to which the media production will be directed. In one particular case, this can be a job jacket as more fully described in U.S. patent application Ser. No. 10/980,405 entitled Systems and Methods for Facilitating Media Production. The entirety of the aforementioned application is incorporated herein by reference for all purposes. With the publication environment defined, device color guides associated with the publication environment are accessed where they have been loaded, or the user is queried to load the particular modules (block 545).

With the device color guides accessed (blocks 545, 550, 555), a color space arbitration is performed (block 575), and the resulting design color space is provided (block 580). This can include, for example, setting the design color space to that of the device color space identified for the publication tool. Then, all transforms from device color spaces are performed to the design color space, and the design color space is also transformed for output to various output device color spaces.

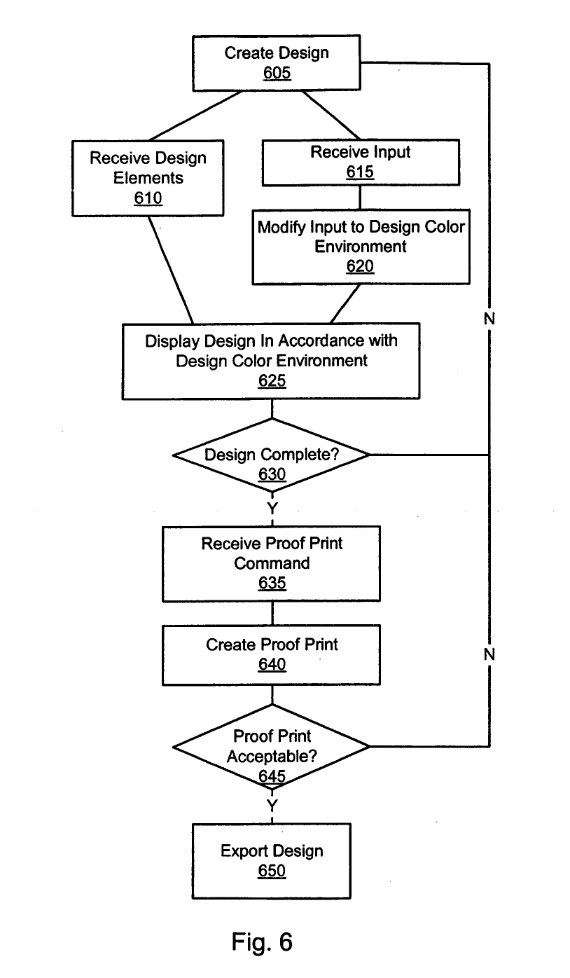

Turning to FIG. 6, a flow diagram 600 depicts another method in accordance with embodiments of the present invention. Following flow diagram 600, a media production is designed (block 605). This design is carried out in a color space tailored for the design and referred to as the design color space. In one particular case, the design color space is a device independent color space. In other cases, the design color space is a device dependent color space. In one particular case, similar to that described in relation to FIG. 3 above, the design color space is chosen to be the color space of a printing press selected to produce the completed design.

As the design is developed (block 605), the various elements of the design are received (block 610). This can include, for example, receiving a request to draw a line or to place some text in the design. These design elements are received from the design tool implementing the design color space, and are thus represented in the design color space. In addition, various elements of the design are received from input devices such as scanners, digital cameras, image capture boards, and/or elements stored on computer readable media (block 615). These elements may be represented in a color space other than that of the design color space, and in such cases the elements are transformed to the design color space (block 620). The combined elements are displayed as the design via a computer monitor (block 625). This allows a designer to see the developing design as represented in the design color space. This process is continued until the design is complete (block 630).

Once the design is complete (block 630) (or at other times during the design), a command to send the design to a proof printer may be received (block 635) and a proof print is created via the proof printer (block 640). In some cases, a transform is performed that makes the color space used by the proof printer conform to the design color space so that what the designer has been viewing during the design process is mapped to that which is produced on the proof printer. In some cases, what the user has been viewing has already been mapped to what the production printing press will create. In such a case, the created proof print will also be closely mapped to that expected from the production printing press. Where the proof print is not acceptable (block 645), the design is modified to alleviate the undesirable features of the proof print (blocks 605-640). Otherwise, where the proof print is acceptable (block 645), the design is exported for printing on a selected printing press (block 650).

As will be appreciated by one of ordinary skill in the art, one or more embodiments of the present inventions can be used to create a relatively user friendly environment in which to manage color. In such an environment, device vendors may provide device color guides that can be loaded and accessed in relation to a desktop publishing suite. A color arbitration can then be performed as selected by a user of the design suite to best map colors from one design to an output, and from inputs to the design. It will further be appreciated that various other advantages can also be achieved through application of one or more embodiments of the present inventions. For example, a color map between various design tools and publication tools can be performed, thereby creating a more accurate design environment. These examples are merely exemplary, and one of ordinary skill in the art will appreciate various other advantages that can be achieved in accordance with the various embodiments of the present inventions.

In conclusion, the present invention provides novel systems, methods and arrangements for media production color management. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A method for color management in a desktop publishing environment, the method comprising:
receiving a project definition, wherein the project definition indicates a publication tool;
receiving a design tool environment definition, wherein the design tool environment definition indicates a design tool;
accessing a device color guide associated with the publication tool;
accessing a device color guide associated with the design tool;
performing color space arbitration between the device color guide associated with the design tool and the device color guide associated with the publication tool; and
based at least in part on the color space arbitration, providing a design color space module.

2. The method of claim 1, wherein performing the color space arbitration includes calculating a color environment common to the publication tool and the design tool.

3. The method of claim 1, wherein performing the color space arbitration includes calculating a color environment that maximizes access to colors available from the publication tool.

4. The method of claim 1, wherein the publication tool is a printing press.

5. The method of claim 4, wherein the printing press is selected from a group consisting of: a four color press, a four color press plus spot color, a four color press plus special plates, and a four color press plus two spot color.

6. The method of claim 4, wherein the project definition further defines at least one ink to be used in relation to the printing press, and wherein the device color guide associated with the printing press is defined based at least in part on the one ink.

7. The method of claim 6, wherein the project definition further defines a paper, and wherein the device color guide associated with the printing press is further defined based at least in part on the paper.

8. The method of claim 1, wherein the design tool is selected from a group consisting of a source design tool and a destination design tool.

9. The method of claim 1, wherein the design tool is selected from a group consisting of a computer monitor, a scanner, a digital still camera, a digital video camera, and a digital design tool.

10. The method of claim 1, wherein the design tool is a first design tool, and wherein the method further comprises:
automatically querying a design tool environment, wherein the query yields the first design tool and at least a second design tool;
presenting the first design tool and the second design tool; and
wherein receiving the design tool environment definition includes receiving a selection of at least the first design tool in response to presenting the first design tool and the second design tool.

11. The method of claim 1, wherein the design tool is a computer monitor, and wherein the design tool environment definition further indicates a proof printer and a scanner.

12. The method of claim 1, wherein the method further comprises:
accessing a device color guide associated with a proof printer;
accessing a device color guide associated with a scanner; and
performing color space arbitration between the device color guide associated with the monitor, the device color guide associated with the proof printer, the device color guide associated with the scanner, and the device color guide associated with the publication tool.

13. The method of claim 1, wherein the publication tool is a printing press, wherein the design tool is a computer monitor, wherein performing color space arbitration between the device color guide associated with the printing press and the device color guide associated with the monitor includes defining the design color space, and wherein the design color space is equivalent to the gamut of the printing press.

14. The method of claim 1, wherein performing color space arbitration between the device color guide associated with the publication tool and the device color guide associated with the design tool includes defining the design color space to include the gamut of the intersection between a first gamut of the device color guide associated with the design tool and a second gamut of the device color guide associated with the publication tool.

15. The method of claim 14, wherein the design tool is a scanner, wherein performing color space arbitration between the device color guide associated with the publication tool and the device color guide associated with the scanner further includes defining the design color space to include a defined color, and wherein the defined color is mapped from the first gamut of the device color guide associated with the scanner to the second gamut of the device color guide associated with the publication tool.

16. The method of claim 15, wherein the defined color is within the second gamut of the device color guide associated with the publication tool, and outside the first gamut of the device color guide associated with the scanner.

17. The method of claim 1, wherein the design tool is a monitor, and wherein the design tool environment definition further indicates a proof printer, and wherein performing the color space arbitration includes defining the design color space to be coextensive with the gamut of the publication tool, and wherein the gamut of the monitor and the gamut of the proof printer are not coextensive with the gamut of the publication tool.

18. A system for color management in a desktop publishing environment, the system comprising:
a microprocessor communicably coupled to a computer readable medium, wherein the computer readable medium includes instructions executable by the microprocessor to:
receive a project definition, wherein the project definition indicates a publication tool;
receive a design tool environment definition, wherein the design tool environment definition indicates at least one design tool;
access a device color guide associated with the publication tool;
access a device color guide associated with the design tool;
perform a color space arbitration between the device color guide associated with the design tool and the device color guide associated with the publication tool; and
based at least in part on the color space arbitration, provide a design color space module.

19. The system of claim 18, wherein the design tool environment definition indicates a monitor and a scanner; wherein the device color guide associated with the design tool indicates a gamut of the scanner and a gamut of the monitor; wherein the device color guide associated with the publication tool indicates a gamut of the publication tool; and wherein the design color space includes a gamut including a transform of the gamut of the monitor, a transform of the gamut of the scanner, and a transform of the gamut of the publication tool.

20. The system of claim 18, wherein the design tool environment definition indicates a proof printer and a monitor; wherein the device color guide associated with the design tool indicates a gamut of the monitor; wherein the device color guide associated with the publication tool indicates a gamut of the publication tool; and wherein the design color space includes a gamut including a transform of the gamut of the monitor, and a transform of the gamut of the publication tool.

21. The system of claim 20, wherein the device color guide associated with the design tool further indicates a gamut of the proof printer; and wherein the design color space further includes a gamut including a transform of the gamut of the proof printer.

22. A method for color management, the method comprising:
defining a publication tool color guide in relation to a printing press;
providing the publication tool color guide to a media production tool, wherein the media production tool is operable to:
receive a project definition, wherein the project definition indicates the printing press;
receive a design tool environment definition, wherein the design tool environment definition indicates a design tool;
access both the publication tool color guide and a design tool color guide associated with the design tool; and
perform a color space arbitration between the publication tool color guide and the design tool color guide, wherein the arbitration defines a design color space.

23. A method for color management in a desktop publishing environment, the method comprising:
maintaining a plurality of design tool color guides, wherein each of the respective design tool color guides defines a gamut associated with a particular design tool;
maintaining a publication tool color guide, wherein the publication tool color guide defines a gamut associated with a particular publication tool;
receiving a selection of at least one of the design tool color guides and the publication tool color guide; and
based at least in part on the at least one of the design tool color guides and the publication tool color guide, defining a color environment.
